(19) United States
(12) Patent Application Publication
(10) Pub. No.: US 2010/0315631 A1
(43) Pub. Date: Dec. 16, 2010

(54) Raman Spectroscopic Apparatus Utilizing Self-Aligned Non-Dispersive External Cavity Laser

(75) Inventors: Xin Jack Zhou, Hockessin, DE (US); Sean Xiaolu Wang, Wilmington, DE (US)

Correspondence Address: BWT PROPERTY, INC., 19 SHEA WAY, SUITE 301, NEWARK, DE, 19713, US

(73) Assignee: BWT PROPERTY, INC., Newark, DE (US)

(21) Appl. No.: 12/797,652

(22) Filed: Jun. 10, 2010

Related U.S. Application Data
(60) Provisional application No. 61/186,028, filed on Jun. 11, 2009.

(51) Int. Cl. G01J 3/44

(52) U.S. Cl. 356/301

(57) ABSTRACT

A Raman spectroscopic apparatus utilizing a self-aligned non-dispersive external cavity laser as the excitation light source. The output spectrum of the laser is narrowed and stabilized by a volume Bragg grating to provide high spectral brightness. A high throughput optical system is used for Raman scattering signal excitation and extraction, which takes full advantage of the high spectral brightness of the laser source.

### REFERENCE TO RELATED APPLICATION

This application claims an invention which was disclosed in Provisional Patent Application Number 61/186,028, filed Jun. 11, 2009, entitled “RAMAN SPECTROSCOPIC APPARATUS UTILIZING SELF-ALIGNED NON-DISPERSIVE EXTERNAL CAVITY LASER”. The benefit under 35 USC §119(e) of the above mentioned United States Provisional Applications is hereby claimed, and the aforementioned application is hereby incorporated herein by reference.

### FIELD OF THE INVENTION

This invention generally relates to a Raman spectroscopic apparatus, and more specifically to a Raman spectroscopic apparatus utilizing a self-aligned non-dispersive external cavity laser as the excitation light source.

### BACKGROUND

Raman spectroscopy has been demonstrated to be a powerful non-invasive analytical technology for material characterization and identification. However, the deployment of Raman spectroscopy has been hindered by the lack of a low cost, rugged, and stable semiconductor laser source that provides high spectral brightness, where the spectral brightness is defined as laser power divided by its spectral linewidth. A broad stripe or broad area diode laser (e.g. a diode laser with a stripe width in the range of 20-500 μm) can provide a high output power of >1 W, while its spectral linewidth is on the order of several nanometers or more due to the existence of a large number of lasing modes in the Fabry-Perot (F-P) laser cavity. This broad linewidth limits the broad stripe laser only to those low resolution Raman spectroscopy applications as disclosed by Clarke et al. in U.S. Pat. Nos. 5,139,334 and 5,982,484. On the other hand, the output power of a single mode diode laser (with a stripe width of a few micrometers) is typically limited to a few hundred milliwatts. This power level is inadequate for Raman spectroscopic analysis of some materials with not so strong Raman scattering. An example of the application of a single mode DBR laser for Raman spectroscopy can be found in U.S. Pat. No. 5,856,869 disclosed by Cooper et al.

Recently, it has been demonstrated that an external cavity laser (ECL) structure can be used to narrow down the linewidth of a broad stripe laser as disclosed by Smith et al. in U.S. Pat. No. 6,100,975 and by Tedesco et al. in U.S. Pat. No. 6,563,854. In these references, the lasing wavelength of the diode laser is locked by a dispersive grating configured in Littrow or Littman configuration. However, these ECL configurations are relatively sensitive to the misalignment of optical components (e.g. lens and grating orientation), temperature fluctuations, and vibrations, which results in poor mechanical and thermal instability.

In another aspect, certain composite material may exhibit strong fluorescence emission under the excitation laser, which often overwhelms the weak Raman signal. Although the fluorescence emission can be partially reduced by employing near infrared (NIR) lasers with longer output wavelengths, the Raman signal also becomes weaker since the Raman scattering cross-section is inversely proportional to the fourth power of the excitation wavelength.

### SUMMARY OF THE INVENTION

It is thus the overall goal of the present invention to solve all the above-mentioned problems and provide a Raman spectroscopic apparatus which utilizes a self-aligned non-dispersive external cavity laser as the excitation light source. The laser light source comprises a high power laser diode and a self-aligned external cavity based on a non-dispersive volume Bragg grating. The volume Bragg grating narrows down the spectral linewidth of the laser diode to provide high spectral brightness as well as good spectral stability.

It is another goal of the present invention to optimize the optical system for Raman signal excitation and extraction in order to take full advantage of the high spectral brightness of the laser light source.

It is yet another goal of the present invention to provide a shifted wavelength excitation technique which utilizes the wavelength tunability of the external cavity laser for fluorescence suppression in Raman spectroscopy.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a block diagram of an exemplary Raman spectroscopic apparatus utilizing a self-aligned non-dispersive external cavity laser as its excitation light source.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a Raman spectroscopic apparatus utilizing a self-aligned non-dispersive external cavity laser as the excitation light source. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises. . .a” does not, without more constraints, preclude the existence of additional identical elements in the process, method, article, or apparatus that comprises the element.

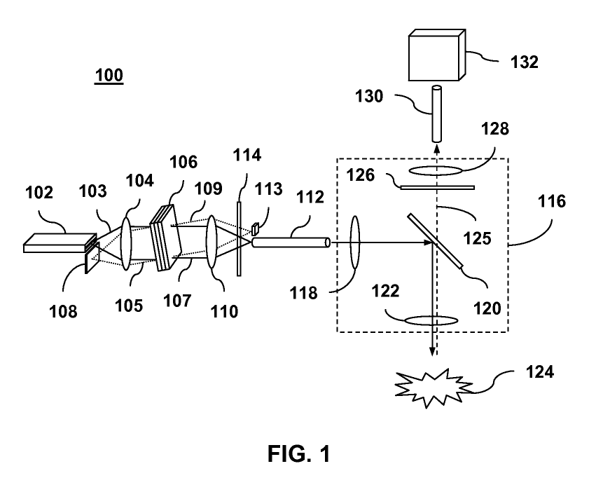

A preferred embodiment of the present invention is shown in FIG. 1. The Raman spectroscopic apparatus 100 comprises a broad stripe laser diode 102 as its excitation light source. The output spectrum of the laser diode 102 is narrowed and stabilized by a self-aligned external cavity formed by a collimating lens 104, a volume Bragg grating 106, and a mirror 108. The mirror 108 is positioned at the plane of the emission facet of the laser diode 102, which is further positioned at the focal plane of the collimating lens 104 such that the output laser beam 103 from the laser diode 102 is collimated by the collimating lens 104. The collimated laser beam is partially diffracted by the volume Bragg grating 106, whose orientation is tilted such that the diffracted laser beam 105 propagates in a direction not parallel to the collimated laser beam. The un-diffracted laser beam 107 serves as the primary output of the external cavity laser (ECL). The diffracted laser beam 105 is focused by the collimating lens 104 onto the mirror 108 and is reflected back to propagate in the opposite direction. Part of the reflected beam is diffracted again by the volume Bragg grating 106 and feed back into the gain medium of the laser diode 102 along the opposite optical path as that of the output laser beam 103. The un-diffracted laser beam 109 forms a second output of the ECL. The spectral bandwidth of the double diffracted laser beam is determined by the bandwidth of the volume Bragg grating 106, while its wavelength is determined by the grating's period and tilt angle. Thus the lasing wavelength of the external cavity laser is locked to the Bragg wavelength of the volume Bragg grating 106 and the spectral linewidth of the laser is reduced by over one order of magnitude in comparison with Fabry-Perot (F-P) type broad stripe diode lasers. The volume Bragg grating 106 can be slanted (grating vector not orthogonal to the surface of the volume Bragg grating) to control its diffraction direction.

The volume Bragg grating based ECL offers several advantages in comparison with Littrow or Littman ECLs that employ dispersive gratings. First, the volume Bragg grating is non-dispersive in nature. Thus the size of the collimated laser beam that incident on the volume Bragg grating can be very small yet still not affecting the grating's diffraction efficiency. As a result, the cavity length of the ECL can be reduced, which enhances the stability of the laser. Second, the present external cavity configuration is self-aligned in the sense that the double diffracted laser beam always propagates back into the laser diode independent of the orientation of the volume Bragg grating, making the laser insensitive to misalignment of optical components (e.g. lens and grating orientation), temperature fluctuations, and vibrations. Third, the output wavelength of the ECL can be tuned by varying the tilt angle of the volume Bragg grating. This feature can be utilized for fluorescence suppression in Raman spectroscopy, which will be disclosed later. The volume Bragg grating also helps to reduce the divergence angle of the laser beam, thus increases the beam's spatial brightness. Here the spatial brightness is defined as the intensity of the laser beam divided by its divergence angle. A more detailed discussion about the self-aligned non-dispersive external cavity laser can be found in Christophe Moser, Lawrence Ho, and Frank Havermeyer, “Self-aligned non-dispersive external cavity tunable laser”, Optics Express, Vol. 16, No. 21, p.16691, Oct. 13, 2008, which is hereby incorporated herein by reference.

The Raman spectroscopic apparatus 100 further comprises an optical system for laser light delivery and Raman scattering signal collection, which is optimized to take full advantage of the high spectral and spatial brightness of the laser source. The primary output laser beam 107 from the ECL is focused by an optical lens 110, e.g. an aspherical lens to be coupled into an optical fiber 112 with a numerical aperture (NA) of about 0.22 and a core diameter of about 50 μm. The numerical aperture and core diameter of the fiber 112 is selected to match with the divergence angle and spot size of the primary output laser beam 107, respectively to maintain the beam's spatial brightness. A laser line filter 114 is inserted between the optical lens 110 and the optical fiber 112 to further suppress the background radiation of the laser. The secondary output laser beam 109 of the ECL is focused by the optical lens 110 onto a photo detector 113 for monitoring the power level of the ECL. The laser light is delivered by the optical fiber 112 into an optical probe 116 for excitation and collection of the Raman scattering signal. The optical probe 116 comprises a first optical lens 118 to collect and collimate the laser beam emitted from the optical fiber 112. The collimated laser beam is then reflected by a dichroic filter 120 to a second optical lens 122. The optical lens 122 focuses the laser beam onto a sample 124 to excite Raman scattering from the sample 124. The high spatial brightness of the ECL makes it possible to focus the laser beam into a small spot for efficient Raman scattering excitation. The optical lens 122 also features a large numerical aperture of about 0.68 for efficient collection of the Raman scattering signal. The collected Raman scattering signal 125 is collimated by the optical lens 122 and passes through the dichroic filter 120 for filtering out the Rayleigh scattering and the reflected laser light from the sample 124. A longpass edge filter 126 following the dichroic filter 120 is used to further remove the Rayleigh scattering from the Raman scattering signal. The filtered Raman scattering signal is focused by a third optical lens 128 into another optical fiber 130. The fiber 130 has a core diameter of about 200 μm and an NA of about 0.22 for collecting the filtered Raman scattering signal and delivering it into a CCD (charge-coupled device) array spectrograph 132 for spectral analysis. It is worth to note that the wavelength of the ECL can be selected from ultraviolet (UV) to near infrared (NIR). Correspondingly, the Raman spectroscopic apparatus built on the ECL can operate in ultraviolet, visible, and infrared wavelength regimes. In a slight variation of the present embodiment, the optical fibers 112, 130 can be omitted to reduce the insertion loss of the optical system.

According to another aspect of the present embodiment, the self-aligned non-dispersive external cavity laser is utilized to implement a shifted wavelength excitation technique for fluorescence suppression in Raman spectroscopy. The shifted wavelength excitation technique had been proposed by Shreve et al. in Applied Spectroscopy, Vol. 46, No. 4, 1992, p.707. However, the lack of a low-cost, high performance tunable laser light source limits the application of the technique. In the present embodiment, the ECL can be tuned to provide two or more output wavelengths, where laser wavelength control is fulfilled by controlling the tilt angle of the volume Bragg grating 106. By exciting the Raman/fluorescence signal at two or more closely spaced wavelengths and performing a subtraction of the obtained Raman/fluorescence spectra, the fluorescence background, which is not influenced by laser wavelength shift, will be suppressed thereby the weak Raman scattering signal can be extracted from a strong fluorescence background. In this embodiment, tuning of the laser wavelength may cause a change in its power level due to the variation in the grating's diffraction efficiency. This can be compensated by coating the mirror 108 to make its reflection coefficient vary in spatial domain in accordance to the tilt angle of the volume Bragg grating 106 or through feedback control of the drive current of the laser diode 102.

In the foregoing specification, specific embodiments of the present invention have been described. However, one of ordinary skill in the art appreciates that various modifications and changes can be made without departing from the scope of the present invention as set forth in the claims below. The numerical values cited in the specific embodiment are illustrative rather than limiting. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A spectroscopic apparatus for measuring the Raman scattering spectrum of a physical material, the spectroscopic apparatus comprising:
a laser light source for producing a laser beam with high spectral and spatial brightness, said laser light source comprising a self-aligned external cavity with a non-dispersive volume Bragg grating as a wavelength selective component;
an optical system for delivering said laser beam to the physical material to excite a scattered optical signal, and for extracting a Raman signal from said scattered optical signal, said optical system utilizes the high spectral and spatial brightness of said laser light source for efficient Raman signal excitation and extraction; and
a spectrograph for measuring a relative intensity of different wavelength components of said Raman signal to obtain a Raman spectrum.

2. The spectroscopic apparatus of claim 1, wherein said laser light source comprises a broad stripe diode laser.

3. The spectroscopic apparatus of claim 1, wherein said self-aligned external cavity further comprises a collimating lens and a reflective optical component positioned at a focal plane of said collimating lens.

4. The spectroscopic apparatus of claim 1, wherein the output wavelength of said laser light source is tunable by adjusting the orientation of said volume Bragg grating.

5. A method for measuring the Raman spectrum of a physical material that exhibits fluorescence, the method comprising the steps of:
providing a laser light source for producing a laser beam, said laser light source comprising a self-aligned external cavity with a non-dispersive volume Bragg grating as a wavelength selective component;
providing an optical system for delivering said laser beam to the physical material to excite a Raman signal and a fluorescence signal;
providing a spectrograph for measuring said Raman and fluorescence signal to obtain a Raman/fluorescence spectrum;
obtaining a plurality of wavelength shifted Raman/fluorescence spectra by tuning the output wavelength of said laser light source; and
mathematically processing said plurality of Raman/fluorescence spectra to extract a Raman spectrum from said plurality of Raman/fluorescence spectra.
